(19) United States
(12) Patent Application Publication
(10) Pub. No.: US 2014/0159637 A1
(43) Pub. Date: Jun. 12, 2014

(54) PORTABLE ENERGY HARVESTING, STORING, AND CHARGING DEVICE

(71) Applicant: EnergyBionics, LLC, Royal Palm Beach, FL (US)

(72) Inventor: Sean Lawrence Ebersold, Wellington, FL (US)

(73) Assignee: EnergyBionics, LLC, Royal Palm Beach, FL (US)

(21) Appl. No.: 13/968,800

(22) Filed: Aug. 16, 2013

Related U.S. Application Data
(60) Provisional application No. 61/684,768, filed on Aug. 19, 2012.

(51) Int. Cl. H02J 7/35; H02J 7/34

(52) U.S. Cl. CPC H02J 7/35; H02J 7/34
USPC 320/101

(57) ABSTRACT

Embodiments of the present invention may provide a portable energy harvesting, energy storage and battery charging device. The portable device consistent with embodiments of the invention may be worn as, for example, a wrist application. The portable device may incorporate any one of, or a combination of, thermoelectric and solar energy harvesting technology as a source for charging, for example, at least one rechargeable battery. The energy may be stored for later use to, for example, recharge portable electronic devices on the go. In various embodiments, the portable device may be configured to provide a time, date and energy supply in a convenient display. Furthermore, the portable device may incorporate, into its design, integrated Universal Serial Bus (USB) connectors for convenient and direct charging of other portable electronic devices. The USB connector may also be configured to cause a charging of the battery of the portable device.

### RELATED APPLICATION

Under provisions of 35 U.S.C. §119(e), the Applicant claims the benefit of U.S. Provisional Application No. 61/684,786, filed on Aug. 19, 2012, which is incorporated herein by reference.

### BACKGROUND

A portable electronic device may be rendered useless when the device runs out of a charge. Consequently, the use of portable electronic devices, such as cellular phones, handheld Personal Digital Assistants (PDA), MP3 Players, gaming devices, smart watches and the like may depend on rechargeable batteries for portability. This may often occur at a time that is not convenient for standard charging through, for example, a wall outlet to recharge the device battery. As a result, outdoor enthusiasts, travelers and tourists, and people who utilize portable electronic devices often experience battery depletion of their devices before standard charging may occur.

### BRIEF DESCRIPTION OF THE DRAWINGS

The accompanying drawings, which are incorporated in and constitute a part of this disclosure, illustrate various embodiments of the present invention. In the drawings:

FIG. 1 illustrates a portable device consistent with embodiments of the present invention;

FIG. 2A depicts a cut out view of a portable device consistent with embodiments of the present invention;

FIG. 2B depicts a side view of a portable device consistent with embodiments of the present invention; and

FIG. 3 illustrates a portable device strap consistent with embodiments of the present invention.

### DETAILED DESCRIPTION

The following detailed description refers to the accompanying drawings. Wherever possible, the same reference numbers are used in the drawings and the following description to refer to the same or similar elements. While many embodiments of the present invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. The present disclosure may contain headers. It should be understood that these headers are used as references and are not to be construed in any way as limiting upon the subjected matter disclosed under the header.

### OVERVIEW

Embodiments of the present invention may provide a portable energy harvesting, energy storage and battery charging device. The portable device consistent with embodiments of the present invention may be worn as, for example, a wrist application. In various embodiments, the portable device may be worn at another location on the body. The portable device may incorporate any one of, or a combination of, thermoelectric and solar energy harvesting technology as a source for charging, for example, at least one rechargeable battery installed within the portable device. The energy may be stored for later use to, for example, recharge portable electronic devices on the go.

In various embodiments, the portable device may be configured to provide a time, date and energy supply in a convenient display. Furthermore, the portable device may incorporate, into its design, integrated Universal Serial Bus (USB) connectors for convenient and direct charging of other portable electronic devices. In certain embodiments, the USB connector may be, for example a micro-USB connector configured to cause a charging of the battery of the portable device. In this way, the micro-USB connector may serve as yet another energy harvesting technology in addition to the thermoelectric and solar harvesting technology. Accordingly, embodiments of the present invention may provide an opportunity for users who prefer the application and use of sustainable energy sources for powering their portable electronic devices.

Some advantages over conventional portable charging devices may be found in, but are not limited to: embodiments comprising a design of the portable device to be worn on the wrist where it may be easily carried, available, and exposed to solar and thermal energy sources; embodiments comprising an integrated USB connector which may avoid a need for a separate USB cable for charging; and embodiments comprising a sustainable and renewable thermoelectric and solar harvesting technology to supply a near constant supply of power. Finally, embodiments of the present invention may use lithium ion battery technology which offers high power rechargeable batteries in a low profile design.

### EXAMPLE EMBODIMENTS

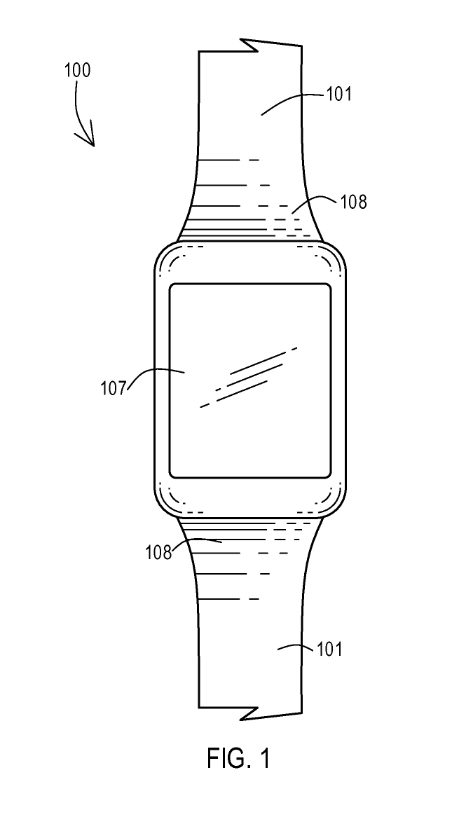

FIGS. 1-3 and the following description depict various embodiments of the present invention to teach those skilled in the art how to make and use the various embodiments of the present invention. Those skilled in the art will observe that the embodiments depicted can be combined and modified in various forms, including various assemblies and circuitry, to create other embodiments of the present invention.

FIG. 1 illustrates an embodiment of the present invention for providing a portable device 100. Portable device 100 may comprise a strap or band 101 used to secure the portable device to a user's wrist. Band 101 may enable portable device 100 to be worn similar to, for example, a wrist watch, smart watch, or the like. Portable device 100 may comprise a solar cell 107. In various embodiments, solar cell 107 may be a monocrystalline solar cell having dimensions suitable to sustain the portability of the portable device. By way of example and not limitation, one set of dimensions for solar cell 107 may be approximately 22×35×2 (mm). Being worn around the user's wrist, solar cell 107 may be exposed to both indoor and outdoor light sources.

Still consistent with embodiments of the present invention, portable device 100 may comprise at least one rechargeable battery 108. Battery 108 may be, for example, a lithium ion battery having dimensions suitable to sustain the portability of the portable device. By way of example and not limitation, one set of dimensions for battery 108 may be approximately 3.8×20×25 (mm). The at least one battery 108 may be designed within an interior of portable device 100 so as to be concealed from an exterior of portable device 100. In some embodiments, battery 108 may be concealed from view by being embedded within band 101. Electricity generated by the energy harvesting technology of portable device 100 may be used to recharge battery 108.

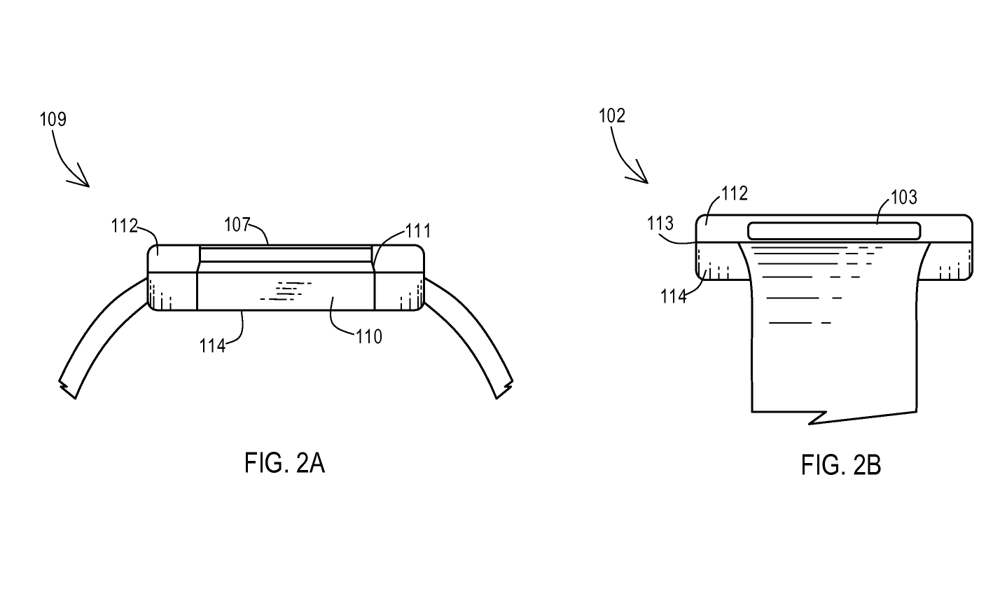

Furthermore, in some embodiments of the present invention, electricity may be generated with a thermoelectric generator in addition to solar cell 107. FIG. 2A illustrates a cutout view 109 of an embodiment of portable device 100 including a thermoelectric generator 110. Thermoelectric generator 110 may have dimensions suitable to sustain the portability of the portable device. By way of example and not limitation, one set of dimensions for thermoelectric generator 110 may be approximately 25×25×5 (mm).

Solar cell 107 and thermoelectric generator 110 may be integrated into a housing of the portable device. For example, the housing may be comprised of an upper portion 112 and lower portion 114. The upper portion 112 may be integrated with solar cell 107, while the lower portion 114 may be integrated with thermoelectric generator 110. To support efficient heat transfer, some embodiments may comprise a heat reservoir 111. Heat reservoir 111 may be placed, for example, in between thermoelectric generator 110 and solar cell 107. In certain embodiments, however, portable device 100 may not comprise thermoelectric generator 110 and/or heat reservoir 111.

Consistent with embodiments of the present invention, lower housing 114 may be comprised of an alloy plate. The allow plate may rest against the user's skin. In this way, body heat may be transferred through the alloy plate to thermoelectric generator 110. The body heat may be absorbed by thermoelectric generator 110 which may use the heat to generate electricity. In turn, the generated electricity may be employed to charge battery 108. In some embodiments, and as described with reference to FIG. 2B below, the absorbed heat may be subsequently radiated out to ambient air via upper portion 112.

FIG. 2B illustrates a side view 102 of an embodiment of portable device 100. As shown in FIG. 2B, portable device 100 may comprise a seam 113 indicating a break and subsequent thermal gap between the upper 112 and lower portion 114. Collectively, the heat reservoir 111 and upper portion 112 may serve as a heat sink causing a thermal temperature difference that, in turn, may allow thermoelectric generator 110 to produce electricity from body heat and the interface of ambient air. The generated electricity may then be used to charge battery 108.

Portable device 100 may further comprise a display 103. Display 103 may be configured to indicate, for example, an energy level of at least one battery 108. In some other embodiments, display 103 may indicate a time and date. In this way, portable device 100 may also serve as, for example, a watch.

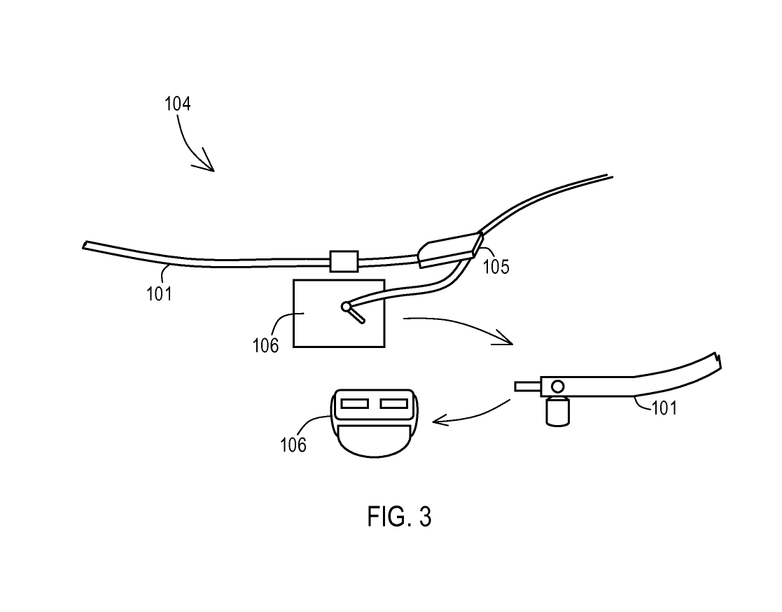

FIG. 3 illustrates a side view 104 of an embodiment of band 101. Band 101 may be comprised of, for example, two separate straps, each attached to portable device 100. The straps may be attached to portable device 100 by, for example, crimping the straps between the upper portion 112 and lower portion 114 of the housing. Moreover, the straps of band 101 may be attached to each other via a latching buckle 105. Latching buckle 105 may be configured to extend or lengthen a connection point of the straps so as to accommodate varying user wrist sizes.

Consistent with embodiments of portable device 100 may comprise both male and female USB connections 106. In some embodiments, wiring may be channeled from the housing of portable device 100 to host a micro-USB connector at, for example, an end of each strap. For example, a male micro-USB connector may be wired into a first strap of band 101. The male micro-USB connector may allow the direct connection from portable device 100 to a portable electronic device requiring a battery charge.

Similarly, a female micro-USB connector may be wired into a second strap of band 101. In some embodiments, the female micro-USB connector may be configured to be within the housing of portable device 100. The female micro-USB connection may enable the charging of at least one battery 108 via, for example, a power supply having a male USB connector configured to connect with the female USB connector of portable device 100. In other embodiments, the female micro-USB may be positioned next to the male micro-USB connector on the same strap.

In using portable device 100, a user may attach the device to his or her wrist and secure band 101 using buckle 105. The display 103 may indicate, along with the time and date, the energy level of the at least one battery 108. When at least one battery 108 has sufficient power, the user may simply connect the male micro-USB connection 106 to a female micro-USB connection on a portable electronic device in need of charging. Upon connection, portable device 100 may be configured to charge a battery of the connected portable electronic device by providing the connected portable device with its own stored energy supply.

Embodiments of the present invention may make use of circuitry that boosts the harvested energy received from the thermoelectric generator 110 and the solar cell 107. The circuitry may be combined or segregated, to an extent, for each energy harvesting device. Such circuitry may be positioned, for example, around thermoelectric generator 110 and solar cell 107 where it may deliver the energy harvested via wiring to the at least one battery 108. Furthermore, additional wiring and circuitry may be employed to deliver regulated power from the at least one battery 108 to the male micro-USB connector for use in charging portable electronic device batteries. Other circuitry and wiring may be employed to charge the at least one battery 108 when a power supply is connected to a female micro-USB connector. The circuitry may be configured to, for example, charge the at least one battery 108 with the current passing through the micro-USB connection. Additional circuitry provides power to the time, date and energy level display 103.

All rights including copyrights in the illustrations included herein are vested in and the property of the Applicant. The Applicant retains and reserves all rights in the illustrations included herein, and grants permission to reproduce the material only in connection with reproduction of the granted patent and for no other purpose.

While the specification includes examples, the present invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

The following is claimed:

1. An apparatus comprising:
a housing;
a solar cell integrated within an exterior portion of the housing;
at least one battery coupled to the solar cell;
a Universal Serial Bus (USB) connector; and
at least one strap coupled to the housing.

2. The apparatus of claim 1, wherein the USB connector is coupled to the housing via wiring embedded within the at least one strap.

3. The apparatus of claim 1, wherein the at least one battery is coupled to the USB connector.

4. The apparatus of claim 3, wherein the USB connector provides a male USB connector.

5. The apparatus of claim 4, wherein the at least one battery is configured to supply energy through the male USB connector.

6. The apparatus of claim 3, wherein the micro-USB connector is a female USB connector.

7. The apparatus of claim 6, wherein the at least one battery is configured to receive energy from the female USB connector.

8. The apparatus of claim 1, wherein the at least one battery is configured to store the energy harvested from the solar cell.

9. The apparatus of claim 1, wherein the at least one battery is located in an interior portion of the housing.

10. The apparatus of claim 1, wherein the at least one battery is embedded within the at least one strap.

11. The apparatus of claim 1, further comprising a display integrated within the exterior portion of the housing.

12. The apparatus of claim 11, wherein the display is configured to indicate an amount of energy stored in the at least on battery.

13. The apparatus of claim 11, wherein the display is configured to indicate at least one of the following: a time and a date.

14. The apparatus of claim 1, wherein the at least one strap is enabled to wrap around a wrist of a user.

15. The apparatus of claim 14, further comprising at least one buckle configured to secure the at least one strap to the wrist of the user.

16. The apparatus of claim 1, further comprising a thermoelectric generator integrated within the exterior portion of the housing.

17. The apparatus of claim 16, wherein the thermoelectric generator is configured to harvest body heat from a user.

18. The apparatus of claim 16, wherein the at least one battery configured to store energy produced by the thermoelectric generator.

19. An apparatus comprising:
a housing;
a solar cell attached to the housing;
a battery coupled to the solar cell;
a Universal Serial Bus (USB) connector coupled to the battery;
a first strap coupled to a first side of the housing; and
a second strap coupled to a second side of the housing.

20. An apparatus comprising:
a housing;
a monocrystalline solar cell attached to an upper portion of the housing;
a lithium ion battery;
a first circuit configured to:
couple the lithium ion battery to the monocrystalline solar cell, and
charge the lithium ion battery with energy harvested by the monocrystalline solar cell;
a male micro-Universal Serial Bus (USB) connection;
a second circuit configured to:
couple the lithium ion battery to the monocrystalline solar cell to the micro-USB connection, and
transfer energy from the lithium ion battery to the micro-USB connection; and
a display indicating an amount of energy stored in the lithium ion battery.
